(19) United States
(12) Patent Application Publication
(10) Pub. No.: US 2025/0199157 A1
(43) Pub. Date: Jun. 19, 2025

(54) ULTRA-WIDEBAND RADAR DEVICE, METHOD FOR AUTHORIZING A CONTROL ACTION AND METHOD FOR SECURE LOCALIZATION

(71) Applicant: Infineon Technologies AG, Neubiberg (DE)

(72) Inventors: Daniel Oloumi, Villach (AT); Alan Paussa, Villach (AT)

(21) Appl. No.: 18/983,694

(22) Filed: Dec. 17, 2024

(30) Foreign Application Priority Data
Dec. 18, 2023 (DE) 102023135498.1

(51) Int. Cl. G01S 13/76; G05B 11/01

(52) U.S. Cl. CPC G01S 13/765; G05B 11/01

(57) ABSTRACT

An ultra-wideband (UWB) radar device including a transmitter configured to generate a first radio signal by modulating a first carrier signal with a first M-sequence and transmit the first radio signal, a receiver configured to receive a radio signal and correlate the received radio signal with a predetermined second M-sequence different from the first M-sequence and a controller configured to authorize a predetermined control action in reaction to a determination, based on the correlation result, that a device has responded to the first radio signal with a second radio signal generated by modulating a second carrier signal with the second M-sequence.

### TECHNICAL FIELD

The present disclosure relates to ultra-wideband radar devices, methods for authorizing a control action, and methods for secure localization.

### BACKGROUND

There is a growing demand and market for devices capable of providing secure localization, anti-spoofing, asset tracking, interference detection, perimeter authentication, and imaging, especially in Internet of Things (IoT) applications. An exemplary use case is, for example, that the correct car door should be opened when a user with a valid key approaches the car from a certain direction. An approach to address these use cases is security localization systems, which incorporate radar transceivers that use short pulses or wide-frequency sweeps along with communication systems like Bluetooth for data exchange between fixed and active tags (such as a tag integrated into a key but also, for example, fixed to a parcel, etc.). While this integration of radar and communication technology (like Bluetooth) is beneficial, it does introduce an additional layer of complexity to the respective system. Therefore, according to various embodiments, efficient and robust approaches for secure localization are desirable.

### SUMMARY

According to various embodiments, an ultra-wideband (UWB) radar device is provided comprising a transmitter configured to generate a first radio signal by modulating a first carrier signal with a first M-sequence and transmit the first radio signal, a receiver configured to receive a radio signal and correlate the received radio signal with a predetermined second M-sequence different from the first M-sequence and a controller configured to authorize a predetermined control action in reaction to a determination, based on the correlation result, that a device has responded to the first radio signal with a second radio signal generated by modulating a second carrier signal with the second M-sequence.

According to a further embodiment, an ultra-wideband radar device is provided comprising a receiver configured to receive a radio signal and correlate the received radio signal with a predetermined first M-sequence and a transmitter configured to, in reaction to a determination, based on the correlation result, that a device has transmitted a first radio signal generated by modulating a first carrier signal with the first M-sequence, to respond to the first radio signal with a second radio signal generated by modulating a second carrier signal with a predetermined second M-sequence different from the first M-sequence.

According to further embodiments, a method for authorizing a control action and a method for secure localization according to the above UWB radar devices are provided.

It should be noted that examples and embodiments described in the context of one of the devices are analogously applicable to the other device and the methods and vice versa.

### BRIEF DESCRIPTION OF THE DRAWINGS

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a communication arrangement according to various embodiments.

FIG. 2 shows a system block diagram of a UWB radar device operating based on M-sequences.

FIG. 3 illustrates the determination of a direction of a source of a radar signal.

FIGS. 4A and 4B illustrate a baseband M-sequence.

FIGS. 4C and 4D show an upconverted M-sequence after reflecting off two targets, along with its spectrum.

FIGS. 4E and 4F show a resulting IF M-sequence.

FIG. 4G shows detection peaks.

FIG. 5 shows a flow diagram illustrating a method for authorizing a control action according to an embodiment.

FIG. 6 shows a flow diagram illustrating a method for secure localization.

### DETAILED DESCRIPTION

The following detailed description refers to the accompanying drawings that show, by way of illustration, specific details, and aspects of this disclosure in which the invention may be practiced. Other aspects may be utilized, and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

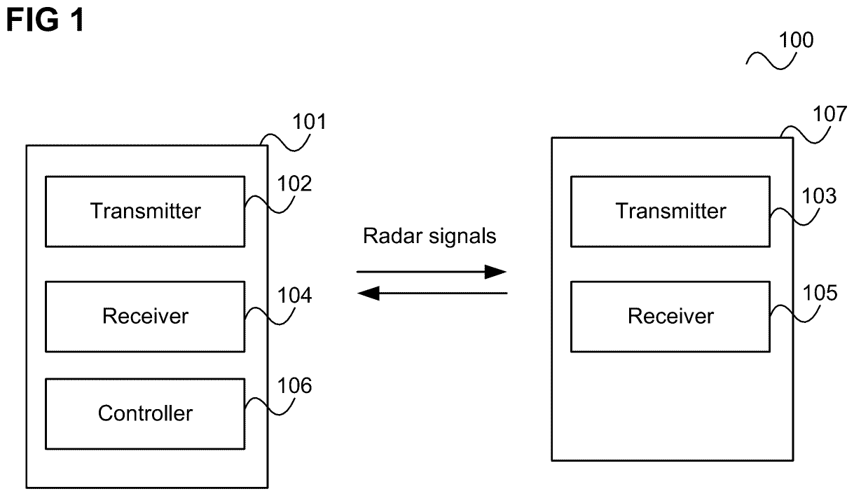

FIG. 1 shows a communication arrangement 100 according to various embodiments.

The communication arrangement 100 comprises a first device 101 and a second device 107 which each include a respective transmitter 102, 103 and a respective receiver 104, 105.

The first device 101 is configured to perform (or at least authorize) a control action depending on whether a second device 107 is present. For example, the first device 101 is a control system including a controller 106 of an object configured to control a component of the object. For example, the object is a house and the controller 106 is supposed to open a door of the house when a user with the house key (e.g., in form of or including a tag) approaches the door. Similarly, the first device 101 may be a control system of a car and should open a car door, ideally the correct car door, when a user having the key for the car approaches. The first device may, for example, also be a control device or system in a factory which localizes assets and performs control actions (e.g., activates machines or robots, e.g., to grab and process the assets etc.). The first device 101 and the second device 107 may, for example, be or comprise IoT (internet of things) devices.

According to the above examples, security is required: for example, if the first device 101 is a control system of a house or a car, it should only open the door if the correct key (and not any key) approaches. Further, depending on the use case, positioning (localization) may be required: the door should for example only be opened when the user actually is near (or comes nearer) and possibly the direction is also important to open the correct door, i.e., the one at which the user arrives (rather than opening all doors which may be undesirable). Depending on the use case (such as when handling an asset (e.g., provided with an electronic tag) in a factory but also when a car should be only opened when the user is very near), high accuracy (i.e., resolution) of the localization may be required.

So, according to various embodiments, approaches are desirable to enable both high resolution for localization and security. Further, it is desirable to achieve this with circuits with low complexity (e.g., to be able to provide tags for assets at low cost). So, for example, usage of Bluetooth and/or pulse radar for these use cases may not be desirable. Further, to achieve high reliability, a high signal-to-noise ratio (SNR) of the communication between the devices 101, 102 should be achieved, and the communication should be robust against interference (i.e., the respective receiving device should be able to receive data from the other device in spite of interference from other signal sources).

According to various embodiments, the above requirements are met by using a UWB (ultra-wide band) radar system or device for the localization of the second device 107 by the first device 101 and for secure communication between the two devices (in particular authentication of the second device 107 with respect to the first device). UWB radar devices have precise ranging capabilities, resilience to interference, and high efficiency.

Specifically, according to various embodiments, a radar device is used (e.g., as the first device 101), which utilizes code-based waveforms, in particular M-sequences for UWB radar signals. These offer a dual advantage: precise high-resolution ranging and encryption and decryption for enhanced security, eliminating the need for an additional (communication) system like Bluetooth for identification and security. Furthermore, the use of digitally generated M-sequences not only simplifies system design but also allows precise control over security and range resolution parameters, including code length, code hopping strategies, system clock settings, as well as pulse rise and fall times. This versatility makes it a desirable choice for a wide range of applications.

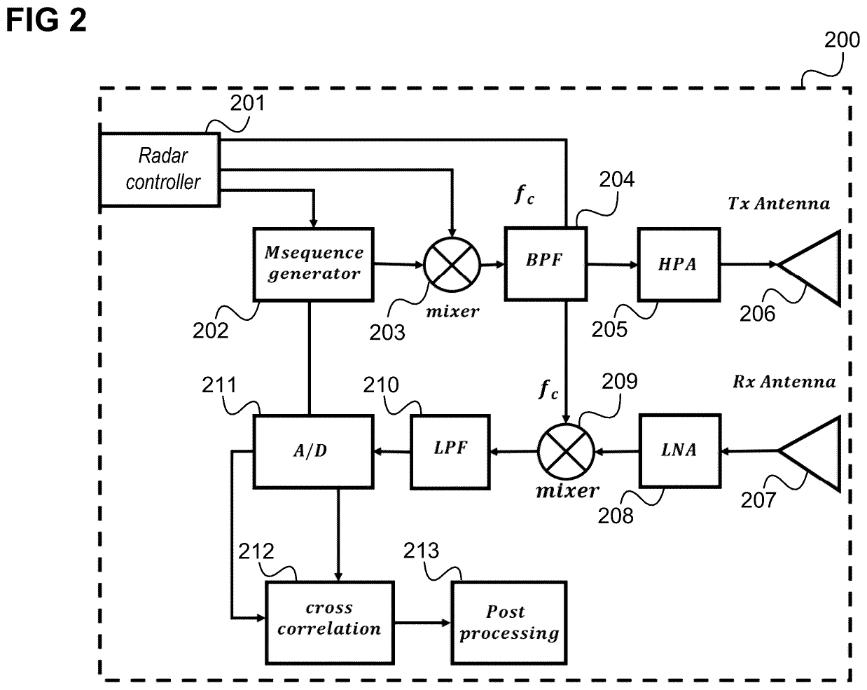

FIG. 2 shows a system block diagram of a UWB radar device 200 operating based on M-sequences. It is, for example, used as (or as a part) of the first device 101 and the second device 107.

The UWB radar device 200 includes a radar controller 201 (which may correspond to the controller 106 but may also be a separate controller of the first device 101) for configuring M-sequence parameters such as clock, rise and fall times, and RF (radio frequency) frequency for up and down conversion. The UWB radar device 200 further comprises a baseband M-sequence generator 202, a first mixer 203 (in the transmission path) for up conversion (of the M-sequences by a carrier frequency fc), and a second mixer 209 (in the reception path). Following the first mixer 203, the transmission path further comprises a bandpass filter (BPF) 204, a high-power amplifier (HPA) 205, and a transmit antenna 206. In the reception path, the UWB radar device 200 comprises at least one receive antenna 207, a low-noise amplifier (LNA) 208, the second mixer 209 followed by a low-pass filter 210 and an A/D (analog to digital) converter 211 which provides a digital receive signal which a cross correlation module 212 correlates with a respective (expected) M-sequence generated by the M-sequence generator 202 to determine whether the received signal contains the M-sequence. From the time shift between the two input sequences to the correlation at which the correlation outputs peaks the radar device 200 can further determine (e.g., by a post-processing module 213) the distance of the signal source of the received signal (containing the expected M-sequence) from the radar device 200.

The cross correlation may be seen as matched filtering effectively removing irrelevant codes (i.e., in particular M-sequences not fitting an expected M-sequence) and reducing interference levels.

For example, when the UWB radar device 200 corresponds to the first device 101, it first transmits a first M-sequence generated by the M-sequence generator 202 (by modulating the carrier signal with it) as a challenge and then checks whether it receives a radar signal containing a second M-sequence generated by the M-sequence generator 202 (which is associated with the first M-sequence according to a predefined scheme (e.g., code-hopping scheme) and which is therefore an M-sequence expected in response by the first device 101). Reception of a radar signal containing the “correct” (i.e., associated) second M-sequence can be seen as the correct response to the challenge. Further, from the result of the correlation with the expected M-sequence, the UWB radar device 200 can determine the range of the signal source having transmitted the received signal containing the expected M-sequence.

In case of a correct response, the first device 101 considers the reception of the correct second M-sequence as a successful authentication of the second device 107 and performs a control action like opening a car door (possibly in combination with other criteria such as that the source of the received signal (i.e., the second device 107) is close to the first device 101 (i.e., its distance is below a certain threshold) and/or the direction of the source of the received signal is in a predetermined (angular) range.

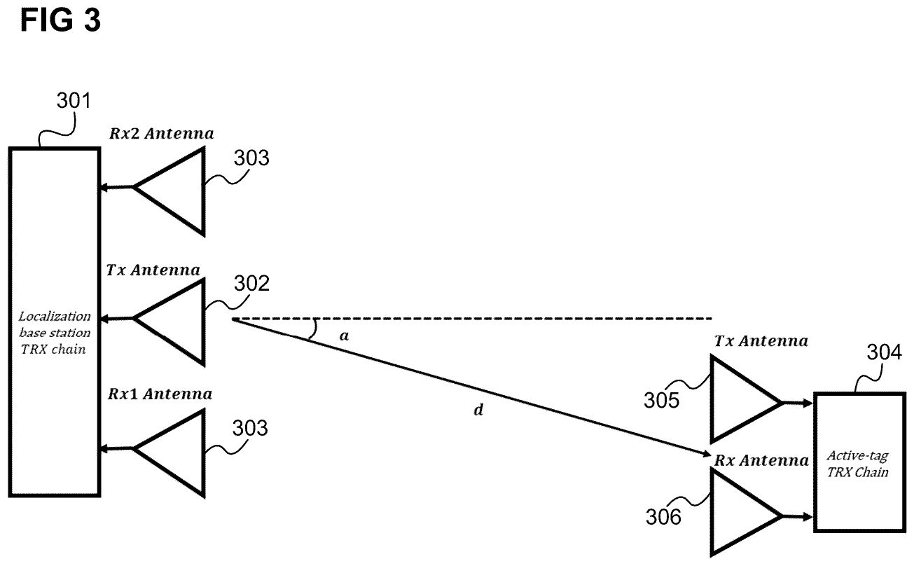

FIG. 3 illustrates the determination of the direction (e.g., as part of the post-processing by the post-processing module 213).

The first device 101 is, in this example, a localization device (e.g., “base station”) 301 having a transmit antenna 302 and two receive antennas 303, and the second device 107 is, in this example, an active tag 304 having a transmit antenna 305 and a receive antenna 306. Both the localization device 301 and the active tag 304 may be configured as a UWB radar device as described with reference to FIG. 2.

As described above, the localization device 301, for example, sends out a challenge (a radar signal containing (carrier modulated by) a first M-sequence), the active tag 304 determines that it has received a radar signal containing the first M-sequence (by correlation with the first M-sequence which it knows, e.g., which it has stored in a memory or for which it is configured in another manner) and responds with the correct second M-sequence (i.e., a radar signal containing (carrier modulated by) the second M-sequence) which it also knows, e.g., has stored. For example, the active tag 304 has a look-up table to know with which (second) M-sequence to respond to a certain received (first) M-sequence or is configured with a predefined generation scheme for the second M-sequence (e.g., depending on a secret key stored in the active tag 304) tells the active tag 304 with which (second) M-sequence to respond.

Further, using its multiple receive antennas 303 (and respective reception circuitry), the localization device 301 may determine the direction (angle of arrival) from which it receives the response (radar signal) from the active tag 304 and may execute a control action depending on the direction (e.g., in addition to range and successful authentication).

It should be noted that an M-sequence-based UWB radar device has a tunable range resolution feature. This adaptability enables adjustments to the transmitted pulse width, with the option to widen it for improved detection at longer distances, reducing free space loss, or narrow it to enhance resolution for closer distances. Such versatility makes it well-suited for various security localization applications. The range resolution may be tuned by controlling pulse characteristics, i.e., adjusting the pulse-width on M-sequence which allows setting a high accuracy where needed (e.g., when the second device 107 is near) and power efficiency by setting the accuracy (and thus required power) lower (e.g., when the second device 107 is further away). So, the first device 101 may control pulse width to adjust the range resolution, e.g., based on the distance and required accuracy, and may manage the radiated power and achieve lower power consumption. Moreover, tuning the pulse width can be another way to reduce interference.

Further, the first device may change the carrier frequency, fc, to hop the pulse spectrum in a synchronized way to add more security against jamming.

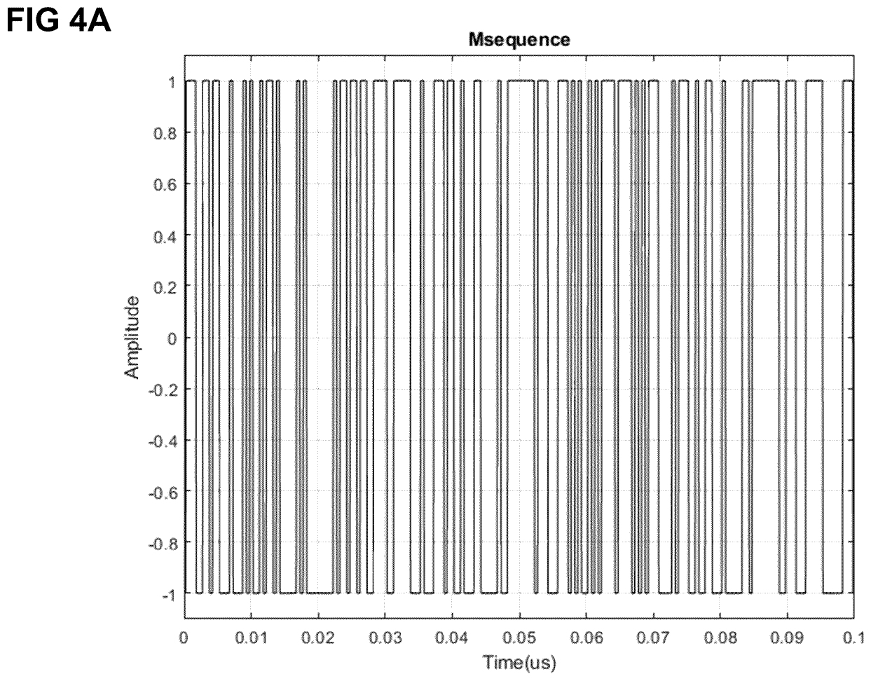

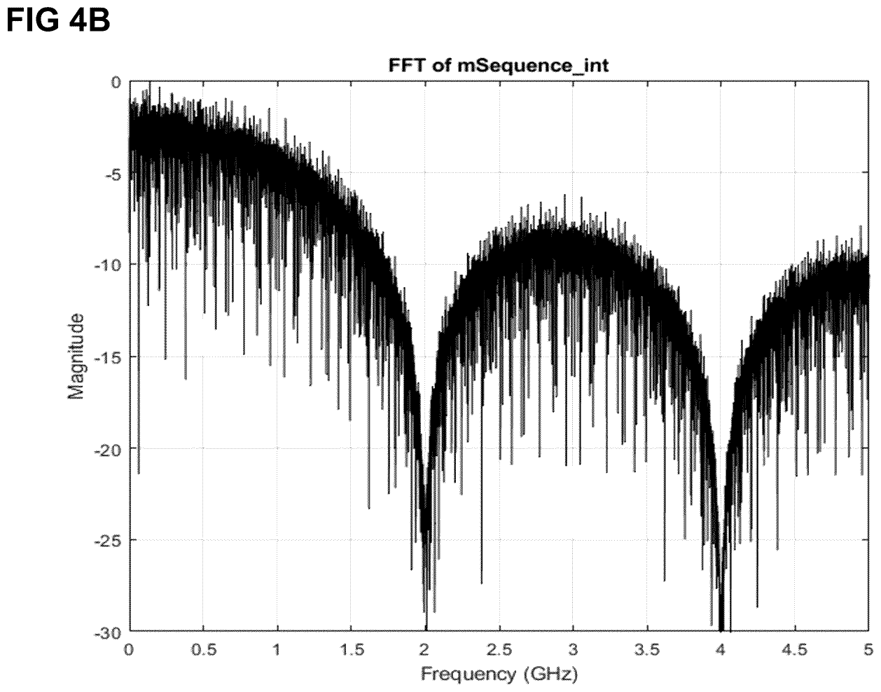

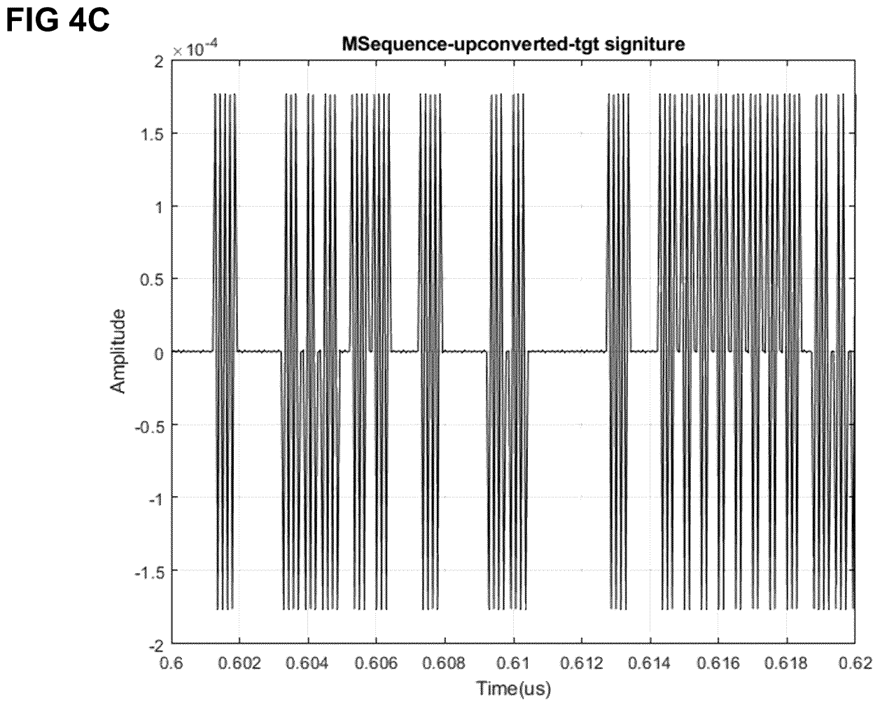

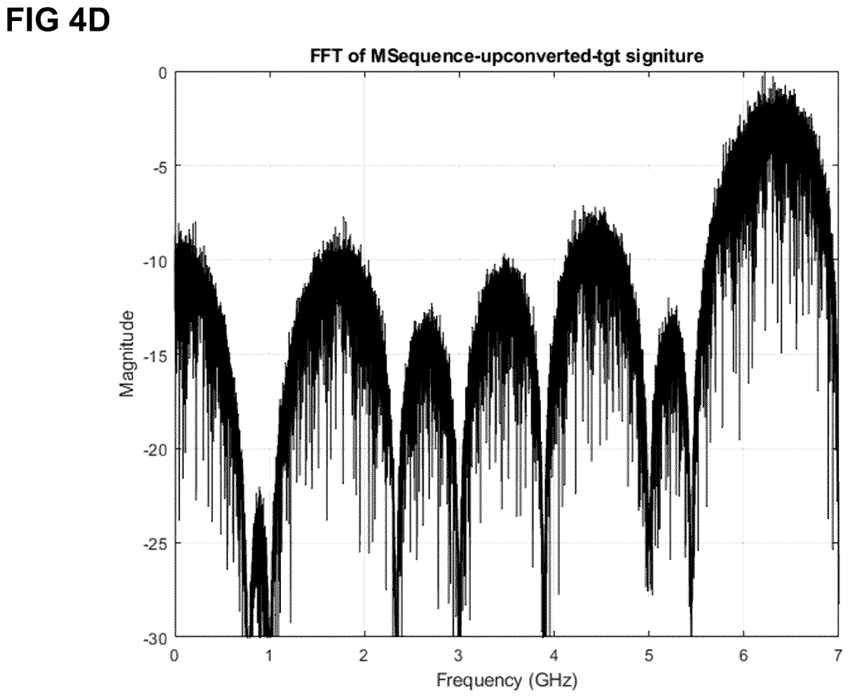

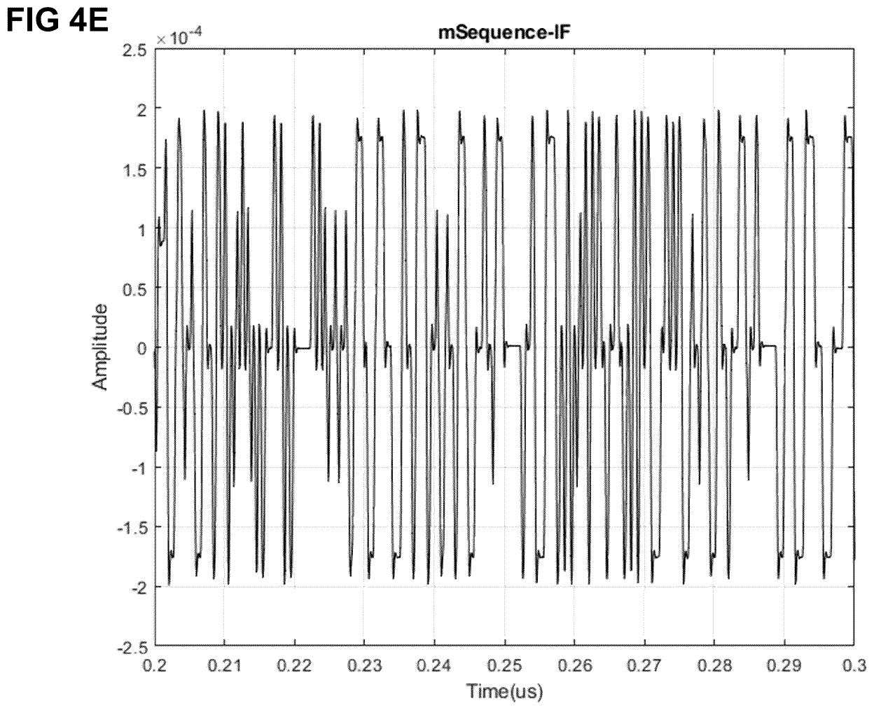

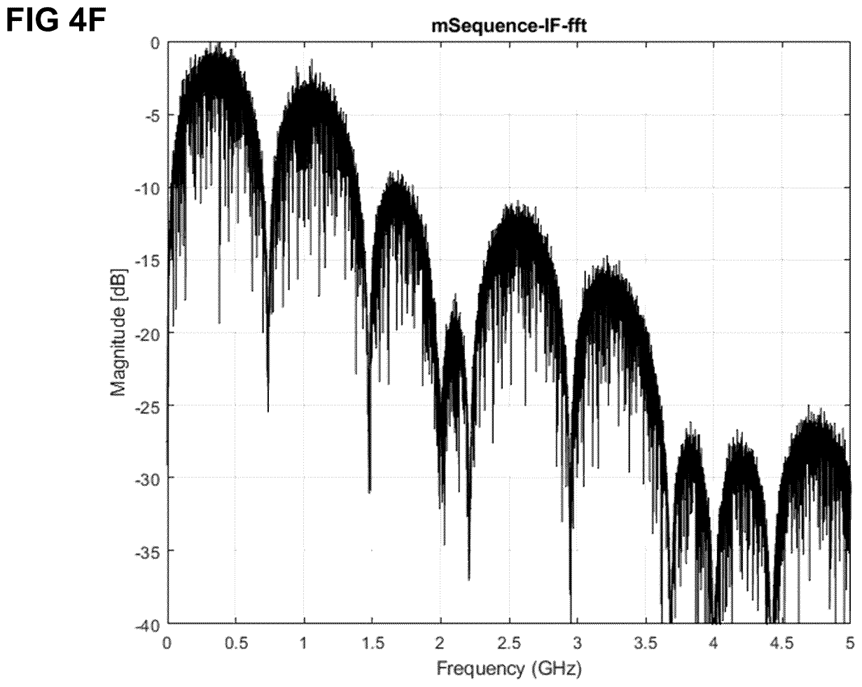

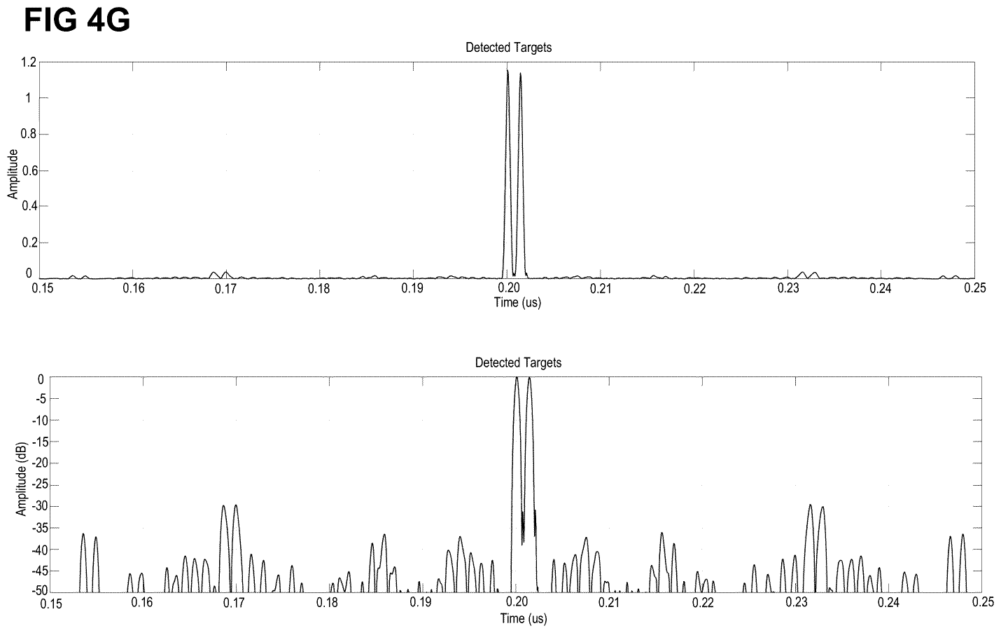

FIGS. 4A and 4B illustrate a baseband M-sequence with a length of 2047, implemented using 11 flip-flops. In this example, a pulse width of 0.5 ns (e.g., clock cycle length) has been selected to achieve a range resolution of ˜10 cm.

FIGS. 4C and 4D show the upconverted M-sequence (i.e., the transmitted radar signal) after reflecting off two targets, along with its spectrum. It should be noted that the up-conversion frequency (i.e., the carrier frequency fc) is, according to various embodiments, set according to a predetermined UWB radiation mask or is dynamically changed depending on the respective radar device's operation strategy.

FIGS. 4E and 4F show the resulting IF M-sequence (i.e., LPF 210 output). As described above, following ADC conversion, the IF M-sequence undergoes matched filtering with the expected M-sequence in the respective (receiving) device, eliminating other codes and minimizing interference. The ADC resolution and sampling frequency are designed depending on the characteristics of the targets to be detected, as well as the required range resolution.

The detected targets are then identified at the appropriate time delay (at which the correlation outputs peaks) corresponding to their distance from the respective device. A longer code length can yield improved side-lobe levels (SLL), potentially surpassing the achieved 30 dB SLL, as shown in FIG. 4G for an example with two targets.

In summary, according to various embodiments, an ultra-wideband radar device (e.g., corresponding to the first device 101) is provided comprising:
a transmitter (e.g., corresponding to transmitter 102) configured to generate a first radio signal by modulating a first carrier signal with a first M-sequence and transmitting the first radio signal;
a receiver (e.g., corresponding to the receiver 104) configured to:
a. receive a radio signal; and
b. correlate the received radio signal with a predetermined second M-sequence different from the first M-sequence; and
a controller (e.g., corresponding to transmitter 106) configured to authorize a predetermined control action in reaction to a determination, based on the correlation result, that a device has responded to the first radio signal with a second radio signal generated by modulating a second carrier signal with the second M-sequence.

It should be noted that the predetermined second M-sequence may be from a set of predetermined second M-sequences, i.e., the ultra-wideband radar device may for example do the correlation for each of a plurality of predetermined second M-sequences, e.g., to identify the type of the target, i.e., the sender of the second radio signal (i.e., the device which has responded). For example, there may be three M-sequences associated with different objects or object types as follows:
M-sequence 1: object type 1
M-sequence 2: object type 2
M-sequence 3: object type 3

This can, for example, be useful to identify people accessing a house or car with different keys or to identify objects in a warehouse. For example, different control actions may be predetermined for the different possible devices or device types (e.g., each device of a predetermined set of devices).

Further, according to various embodiments, an ultra-wideband radar device (e.g., corresponding to the device 107) is provided comprising:
a receiver (e.g., corresponding to the receiver 105) configured to
a. receive a radio signal; and
b. correlate the received radio signal with a predetermined first M-sequence; and
a transmitter (e.g., corresponding to the transmitter 103) configured to, in reaction to a determination, based on the correlation result, that a device has transmitted a first radio signal generated by modulating a first carrier signal with the first M-sequence, to respond to the first radio signal with a second radio signal generated by modulating a second carrier signal with a predetermined second M-sequence different from the first M-sequence.

According to various embodiments, in other words, e.g., in addition to the localization of a second device by a first device, the second device is authenticated by the first device by a challenge-response scheme wherein the challenge is a radar signal generated based on (i.e., by modulating a carrier signal with) a first M-sequence, and the response is a radar signal generated based on a second M-sequence (e.g., associated with the first M-sequence according to a predetermined association or code hopping scheme, by a key stored in the second device, etc.). The second device can be configured to respond only to the first M-sequence (or to any of a set of predetermined M-sequences).

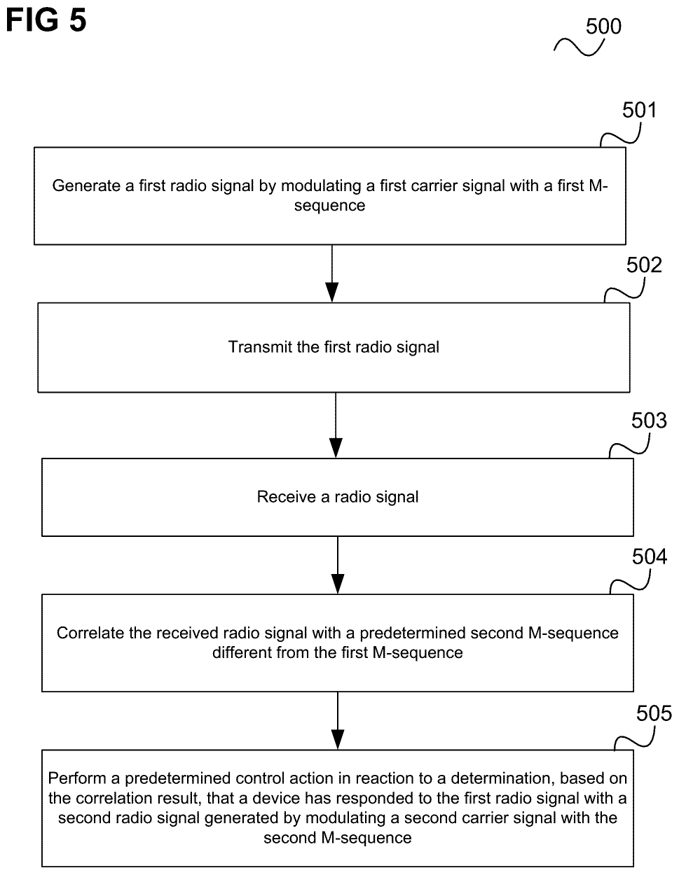

FIG. 5 shows a flow diagram 500 illustrating a method for authorizing a control action according to an embodiment, e.g., performed by the first device 101.

In 501, a first radio signal is generated by modulating a first carrier signal with a first M-sequence.

In 502, the first radio signal is transmitted.

In 503, a radio signal is received (after sending the first radio signal when a response to the first radio signal can be expected).

In 504, the received radio signal is correlated with a predetermined second M-sequence different from the first M-sequence.

In 505, a predetermined control action is performed in reaction to a determination, based on the correlation result, that a device has responded to the first radio signal with a second radio signal generated by modulating a second carrier signal with the second M-sequence.

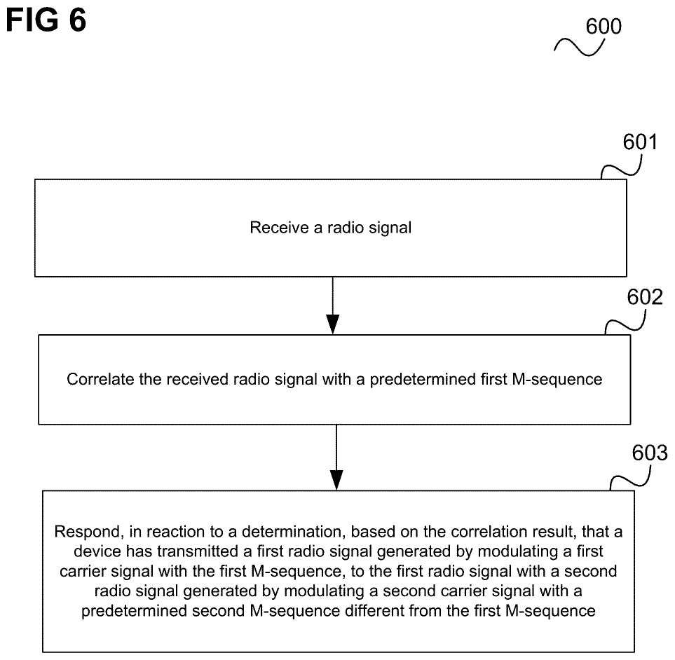

FIG. 6 shows a flow diagram 600 illustrating a method for secure localization, e.g., performed by the second device 107.

In 601, a radio signal is received.

In 602, the received radio signal is correlated with a predetermined first M-sequence (e.g., the second device 107 continuously receives and correlates with the predetermined first M-sequence).

In 603, in reaction to a determination, based on the correlation result, that a device has transmitted a first radio signal generated by modulating a first carrier signal with the first M-sequence, it responded to the first radio signal with a second radio signal generated by modulating a second carrier signal with a predetermined second M-sequence different from the first M-sequence.

Various Examples are described in the following:

Example 1 is an ultra-wideband radar device comprising a transmitter configured to generate a first radio signal by modulating a first carrier signal with a first M-sequence and transmit the first radio signal, a receiver configured to receive a radio signal and correlate the received radio signal with a predetermined second M-sequence different from the first M-sequence and a controller configured to authorize a predetermined control action in reaction to a determination, based on the correlation result, that a device has responded to the first radio signal with a second radio signal generated by modulating a second carrier signal with the second M-sequence.

Example 2 is the ultra-wideband radar device of example 1, wherein the ultra-wideband radar device is configured to store information associating the second M-sequence with the first M-sequence.

Example 3 is the ultra-wideband radar device of example 2, wherein the information defines the second M-sequence as an expected response to the first M-sequence.

Example 4 is the ultra-wideband radar device of any one of examples 1 to 3, wherein the determiner is configured to determine the second M-sequence depending on the first M-sequence.

Example 5 is the ultra-wideband radar device of any one of examples 1 to 4, wherein the determiner is configured to determine the second M-sequence depending on the first M-sequence according to a predefined association of M-sequences.

Example 6 is the ultra-wideband radar device of any one of examples 1 to 5, wherein the determiner is configured to determine the first M-sequence and the second M-sequence according to a code hopping scheme defining a series of M-sequences.

Example 7 is the ultra-wideband radar device of any one of examples 1 to 6, wherein the receiver is further configured to determine a distance of the device responding with the second radio signal to the ultra-wideband radar device using the received signal and wherein the controller is configured to authorize and/or select the control action depending on the distance.

Example 8 is the ultra-wideband radar device of any one of examples 1 to 7, wherein the receiver is further configured to determine a direction of the device responding with the second radio signal with respect to the ultra-wideband radar device using the received signal and wherein the controller is configured to authorize and/or select the control action depending on the direction.

Example 9 is the ultra-wideband radar device of example 8, wherein the receiver is configured to receive the signal using a plurality of receive antennas and determine the direction based on reception differences between the receive antennas.

Example 10 is the ultra-wideband radar device of any one of examples 1 to 9, wherein the control action is a control of a component of an object connected to or containing the ultra-wideband radar device.

Example 11 is the ultra-wideband radar device of example 10, wherein the controller is configured to select the component among a plurality of components of the object depending on the direction.

Example 12 is the ultra-wideband radar device of any one of examples 1 to 11, wherein the control action is opening a lock.

Example 13 is the ultra-wideband radar device of any one of examples 1 to 12, wherein the transmitter is configured to set a pulse width of the first M-sequence depending on a predetermined desired range resolution.

Example 14 is the ultra-wideband radar device of any one of examples 1 to 13, wherein the transmitter is configured to set a pulse width of the first M-sequence depending on a previous estimation of the distance of the device responding with the second radio signal.

Example 15 is the ultra-wideband radar device of example 14, wherein the transmitter is configured to set a pulse width of the first M-sequence to a first pulse width smaller than a second pulse width if the previous estimation is below a predetermined distance threshold and is configured to set the pulse width of the first M-sequence to the second pulse width if the previous estimation is above a predetermined distance threshold.

Example 16 is the ultra-wideband radar device of any one of examples 1 to 15, wherein the transmitter configured is configured to generate a series of first radio signals by, for each first radio signal, modulating a respective first carrier signal with the first M-sequence and to transmit the series of first radio signals and wherein the receiver is configured to receive a series of radio signals and, for each received radio signal, correlate the received radio signal with the predetermined second M-sequence and wherein the controller is configured to authorize the predetermined control action in reaction to a determination, based on the correlation result, that a device has responded to one of the first radio signals with the second radio signal.

Example 17 is the ultra-wideband radar device of any one of examples 1 to 16, wherein the receiver is configured to perform the determination, based on the correlation result, whether a device has responded to the first radio signal with a second radio signal generated by modulating a second carrier signal with the second M-sequence.

Example 18 is the ultra-wideband radar device of any one of examples 1 to 17, wherein the predetermined second M-sequence is a second M-sequence from a set of predetermined second M-sequences, wherein each of the second M-sequences is associated with a respective device of a set of devices and wherein the receiver is configured to identify the device which has responded to the first radio signal by determining the device of the set of devices which is associated with the second M-sequence of the set of predetermined second M-sequences with which the second carrier signal has been modulated to generate the second radio signal.

Example 19 is an ultra-wideband radar device comprising a receiver configured to receive a radio signal and correlate the received radio signal with a predetermined first M-sequence and a transmitter configured to, in reaction to a determination, based on the correlation result, that a device has transmitted a first radio signal generated by modulating a first carrier signal with the first M-sequence, to respond to the first radio signal with a second radio signal generated by modulating a second carrier signal with a predetermined second M-sequence different from the first M-sequence.

Example 20 is a method for authorizing a control action as described with reference to FIG. 5.

Example 21 is a method for secure localization as described with reference to FIG. 6.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

### REFERENCE SIGNS

100 communication arrangement
101 first device
102, 103 transmitters
104, 105 receivers
106 controller
107 second device
200 UWB radar device
201 radar controller
202 M-sequence generator
203 mixer
204 bandpass filter
205 high-power amplifier
206 transmit antenna
207 receive antenna
208 low-noise amplifier
209 mixer
210 low-pass filter
211 A/D converter
212 cross correlation module
213 post-processing module
301 localization device
302 transmit antenna
303 receive antennas
304 active tag
305 transmit antenna
306 receive antenna
500 flow diagram
501-505 processing
600 flow diagram
601-603 processing

What is claimed is:

1. An ultra-wideband radar device, comprising:
a transmitter configured to generate a first radio signal by modulating a first carrier signal with a first M-sequence and transmit the first radio signal;
a receiver configured to:
receive a radio signal; and
correlate the received radio signal with a predetermined second M-sequence different from the first M-sequence; and
a controller configured to authorize a predetermined control action in reaction to a determination, based on the correlation result, that a device has responded to the first radio signal with a second radio signal generated by modulating a second carrier signal with the second M-sequence.

2. The ultra-wideband radar device of claim 1, wherein the ultra-wideband radar device is configured to store information associating the second M-sequence with the first M-sequence.

3. The ultra-wideband radar device of claim 2, wherein the information defines the second M-sequence as an expected response to the first M-sequence.

4. The ultra-wideband radar device of claim 1, wherein the second M-sequence is determined depending on the first M-sequence.

5. The ultra-wideband radar device of claim 1, wherein the second M-sequence is determined depending on the first M-sequence according to a predefined association of M-sequences.

6. The ultra-wideband radar device of claim 1, wherein the first M-sequence and the second M-sequence are determined according to a code hopping scheme defining a series of M-sequences.

7. The ultra-wideband radar device of claim 1, wherein the receiver is further configured to determine a distance of the device responding with the second radio signal to the ultra-wideband radar device using the received signal and wherein the controller is configured to authorize and/or select the control action depending on the distance.

8. The ultra-wideband radar device of claim 1, wherein the receiver is further configured to determine a direction of the device responding with the second radio signal with respect to the ultra-wideband radar device using the received signal and wherein the controller is configured to authorize and/or select the control action depending on the direction.

9. The ultra-wideband radar device of claim 8, wherein the receiver is configured to receive the signal using a plurality of receive antennas and determine the direction based on reception differences between the receive antennas.

10. The ultra-wideband radar device of claim 1, wherein the control action is a control of a component of an object connected to or containing the ultra-wideband radar device.

11. The ultra-wideband radar device of claim 10, wherein the controller is configured to select the component among a plurality of components of the object depending on the direction.

12. The ultra-wideband radar device of claim 1, wherein the control action is opening a lock.

13. The ultra-wideband radar device of claim 1, wherein the transmitter is configured to set a pulse width of the first M-sequence depending on a predetermined desired range resolution.

14. The ultra-wideband radar device of claim 1, wherein the transmitter is configured to set a pulse width of the first M-sequence depending on a previous estimation of a distance of the device responding with the second radio signal.

15. The ultra-wideband radar device of claim 14, wherein the transmitter is configured to set a pulse width of the first M-sequence to a first pulse width smaller than a second pulse width if the previous estimation is below a predetermined distance threshold and is configured to set the pulse width of the first M-sequence to the second pulse width if the previous estimation is above a predetermined distance threshold.

16. The ultra-wideband radar device of claim 1, wherein the transmitter configured is configured to generate a series of first radio signals by, for each first radio signal, modulating a respective first carrier signal with the first M-sequence and to transmit the series of first radio signals and wherein the receiver is configured to receive a series of radio signals and, for each received radio signal, correlate the received radio signal with the predetermined second M-sequence and wherein the controller is configured to authorize the predetermined control action in reaction to a determination, based on the correlation result, that a device has responded to one of the first radio signals with the second radio signal.

17. The ultra-wideband radar device of claim 1, wherein the receiver is configured to perform the determination, based on the correlation result, whether a device has responded to the first radio signal with a second radio signal generated by modulating a second carrier signal with the second M-sequence.

18. The ultra-wideband radar device of claim 1, wherein the predetermined second M-sequence is a second M-sequence from a set of predetermined second M-sequences, wherein each of the second M-sequences is associated with a respective device of a set of devices and wherein the receiver is configured to identify the device which has responded to the first radio signal by determining the device of the set of devices which is associated with the second M-sequence of the set of predetermined second M-sequences with which the second carrier signal has been modulated to generate the second radio signal.

19. An ultra-wideband radar device, comprising:
a receiver configured to:
receive a radio signal; and
correlate the received radio signal with a predetermined first M-sequence; and
a transmitter configured to, in reaction to a determination, based on the correlation result, that a device has transmitted a first radio signal generated by modulating a first carrier signal with the first M-sequence, to respond to the first radio signal with a second radio signal generated by modulating a second carrier signal with a predetermined second M-sequence different from the first M-sequence.

20. A method for authorizing a control action, comprising:
generating a first radio signal by modulating a first carrier signal with a first M-sequence;
transmitting the first radio signal;
receiving a radio signal;
correlating the received radio signal with a predetermined second M-sequence different from the first M-sequence; and
performing a predetermined control action in reaction to a determination, based on the correlation result, that a device has responded to the first radio signal with a second radio signal generated by modulating a second carrier signal with the second M-sequence.

21. A method for secure localization, comprising:
receiving a radio signal; and
correlating the received radio signal with a predetermined first M-sequence; and
responding, in reaction to a determination, based on the correlation result, that a device has transmitted a first radio signal generated by modulating a first carrier signal with the first M-sequence, to the first radio signal with a second radio signal generated by modulating a second carrier signal with a predetermined second M-sequence different from the first M-sequence.
